(19) United States
(12) Patent Application Publication
(10) Pub. No.: US 2005/0136274 A1
(43) Pub. Date: Jun. 23, 2005

(54) Label film laminate

(76) Inventors: Markus Hamulski, Gronau-Epe (DE); Halina Hamulski, Gronau-Epe (DE); Maik Hach, Gronau-Epe (DE)

Correspondence Address: WILLIAM COLLARD;COLLARD & ROE, P.C., 1077 NORTHERN BOULEVARD, ROSLYN, NY, 11576, US

(21) Appl. No.: 10/994,946

(22) Filed: Nov. 22, 2004

(30) Foreign Application Priority Data
Dec. 18, 2003 (DE) 103 59 366.7

(51) Int. Cl. B32B 27/08; B32B 1/00

(52) U.S. Cl. 428/516; 428/336

(57) ABSTRACT

A label film laminate has a carrier and a label film that can be released from the carrier and can be punched and imprinted. The label film is based on a single-layer or multi-layer extrusion film of polyethylene, whereby the extrusion film has a film thickness of less than 85 μm, and is made up of, at least in outer zones, on both sides, of a high-density polyethylene (HDPE) having a density of more than 0.950 g/cm³.

### CROSS REFERENCE TO RELATED APPLICATIONS

Applicant claims priority under 35 U.S.C. §119 of German Application No. 103 59 366.7 filed Dec. 18, 2003.

### BACKGROUND OF THE INVENTION

1. Field of the Invention

The present invention relates to a label film laminate having a carrier and a label film that can be released from the carrier and can be punched and imprinted. The label film should have a sufficient flexural strength so that it can be processed in usual labeling devices. For cost reasons, the smallest possible film thickness is aimed at. Furthermore, the label film should be characterized by good punching properties, and should be imprintable.

2. The Prior Art

A label film laminate is known from U.S. Pat. No. 4,946,532 in which the label film is made from a three-layer extrusion film produced by means of co-extrusion. This extrusion film has a core layer of polyethylene and non-olefin skin layers, preferably of ethylene vinyl acetate. The thickness of the core layer is sized so that the label film has sufficient flexural strength for processing in labeling devices. The polyethylene used in the core layer can have a density between 0.915 g/cm³ and 0.965 g/cm³.

A multi-layer label film is known from U.S. Pat. No. 6,040,027, the core layer of which is made from polypropylene or a polypropylene copolymer with solids embedded in it. The flexural strength of the label film is influenced by means of microparticle solids that are added in an amount of up to 40 wt.-%. Skin layers made of a non-olefin polymer, preferably of ethylene vinyl acetate, follow the core layer on one or both sides. Film thickness values between 38 μm and 165 μm are indicated.

Commercially available polyethylene films that are used as label films in a label film laminate have a thickness of more the 85 μm and in most cases a thickness of more than 100 μm.

### SUMMARY OF THE INVENTION

In view of this background, it is an object of the invention to provide a label film of polyethylene for a label film laminate having the characteristics described initially, which has good usage properties, while having the smallest possible film thickness. In particular, the film should also possess good flexural strength.

These and other objects are achieved in accordance with the invention by a label film based on a single-layer or multi-layer extrusion film of polyethylene, whereby the extrusion film has a film thickness of less than 85 μm, and is made up of, at least in outer areas or zones, on both sides, of a high-density polyethylene (HDPE) having a density of more than 0.950 g/cm³.

According to the bending theory for solid bodies (DUBBEL, Volume 1, 1970 edition, page 363), the outer areas or zones undergo lengthening or shortening in the case of bending about a neutral fiber of the body. The invention is based on the consideration that the use of a stiff material in the outer zones has a greater influence on the flexural strength of the film than the use of such a material in the region of the neutral fiber. High-density polyethylene is a stiff plastic that imparts great flexural strength to the label film, if it is used in the outer zones of the film, in accordance with an aspect of the invention. By means of the invention, it is possible to reduce the film thickness of the label film to values of approximately 70 μm.

In another embodiment, the extrusion film has multiple layers. The film has a core layer of a polyethylene having a low density, namely a polyethylene having a density of less than 0.945 g/cm³, between outer layers that are made up of a high-density polyethylene (HDPE). Low-density (LDPE) polyethylenes and linear low-density (LLDPE) polyethylenes can be used as the polyethylene having a low density. The outer layers (zones), made up of a high-density polyethylene, have a layer thickness of at least 15 μm, preferably a thickness between 18 μm and 25 μm.

The extrusion film may be a single-layer monofilm made of high-density polyethylene (HDPE) having a density of more than 0.950 g/cm³. In a single-layer monofilm, the outer zones or areas make a greater contribution to the flexural strength than the core region in the region of the neutral fiber.

The surface of the extrusion film can be surface-treated, for example, with corona discharges. At least one side of the extrusion film may also be additionally coated with a polymer to improve the adhesion of inks and adhesives. According to a preferred embodiment of the invention, the coating subsequently applied to the extrusion film by means of extrusion or co-extrusion is made up of an acrylic polymer. The coating can be applied in a thin layer. The layer thickness of the layer subsequently applied is generally significantly less than the layer thickness of the outer zone made up of HDPE, which is required to give the label film sufficient flexural strength. The coating of the extrusion film generally has a layer thickness of not more than 0.1 μm to 5 μm.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a greatly enlarged representation of a cross-section through a label film laminate,

FIG. 2 shows the cross-section through a label film of the label film laminate shown in FIG. 1,

FIG. 3 is a greatly enlarged representation of another embodiment of the label film according to the invention, also in cross-section.

### DETAILED DESCRIPTION OF PREFERRED EMBODIMENTS

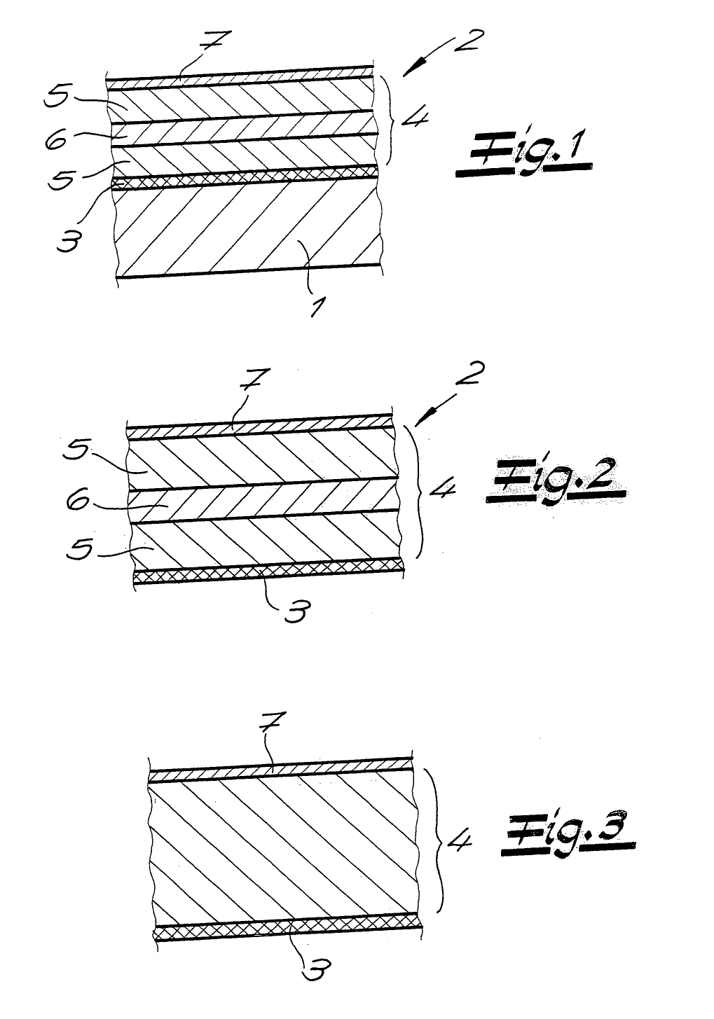

The label film laminate shown in FIG. 1 has a carrier 1 as well as a label film 2 that can be released from carrier 1, and can be punched and imprinted. After being released from carrier 1, label film 2 is self-adhesive, by means of an adhesive 3 that adheres on the underside.

Label film 2 is based on a single-layer or multi-layer extrusion film 4 of polyethylene, the film thickness of which is less than 85 μm and preferably approximately 70 μm. Extrusion film 4 is made up, on both sides, at least in other areas or zones 5, of a high-density polyethylene (HDPE) having a density of more than 0.950 g/cm³. In the exemplary embodiment of FIG. 2, extrusion film 4 is configured in three layers, and the outer zones or areas of HDPE are outer layers 5. Film 4 has a core layer 6 of a polyethylene of low-density having a density of less than 0.945 g/cm³, between the two outer layers 5 of HDPE. Core layer 6 is made up of an LDPE or LLDPE polyethylene. Outer zones or layers 5 of HDPE impart sufficient flexural strength to label film 2 for further processing in labeling devices, and have a layer thickness of at least 15 μm. Preferably, outer zones 5 have a thickness between 18 μm and 25 μm. In the exemplary embodiment, core layer 6 is in direct contact with the two outer layers 5. However, thin adhesion agent layers can also be provided between layers 5, 6, in order to improve the laminate strength.

Extrusion film 4 can additionally be coated with a polymer to improve the adhesion of inks and adhesives, on at least one side. In the exemplary embodiment, a coating 7 of an acrylic polymer having a layer thickness of less than 4 μm is applied on one side of the film. Before the surface coating process, it is practical if extrusion film 4 undergoes a surface treatment with a corona discharge. The corona discharge surface treatment is done so that coating 7 which is subsequently applied adheres better. Coating 7 that is subsequently applied improves the anchoring of inks and adhesives on extrusion film 4 and does not make a significant contribution to the flexural strength of the label film, because of its low layer thickness, which is significantly less than the thickness of outer layers 5.

In the exemplary embodiment shown in FIG. 3, extrusion film 4 is a single-layer monofilm of high-density polyethylene (HDPE) having a density of more than 0.950 g/cm³. The film thickness is less than 85 μm and preferably amounts to about 70 μm. Extrusion film 4 can additionally be coated on at least one side with a polymer, e.g. an acrylic polymer, to improve the adhesion of inks and adhesives. The layer thickness of this subsequently applied layer 7 lies in the range between 0.1 μm and a maximum of 5 μm, and has only an insignificant effect on the flexural strength of the films.

In the following, the invention will be explained using several examples:

### EXAMPLE 1

A film of HDPE (density 0.958 g/cm³, melt index 6 g/10 min at 190° C. and 2.16 kg), having a thickness of 73 μm, was extruded using a broad-slit die. After the melt had been cooled on three water-cooled rollers, the extrusion film was surface-treated in a corona station, and wound up. The label film was subsequently applied to a carrier, imprinted, and punched out, in a laminating system. It was possible to apply the labels to polyethylene bottles at a high speed.

### EXAMPLE 2

A label film of HDPE (density 0.958 g/cm³, melt index 6 g/10 min at 190° C. and 2.16 kg), having a thickness of 70 μm, was extruded on a film blowing system. After a surface treatment using corona discharges, the film was coated with an acrylic polymer and, after UV curing, wound up. As in Example 1, the film was usable for labeling containers.

### EXAMPLE 3

A three-layer label film was produced by co-extrusion on a film blowing system. The total thickness of the film was 75 μm. The two outer layers had a thickness of 20 μm, in each instance, and consisted of an HDPE polyethylene (density 0.960 g/cm³, melt index 8 g/10 min at 190° C. and 2.16 kg). The core layer had a thickness of 35 μm and consisted of an LDPE polyethylene (density 0.922 g/cm³, melt index 2 g/10 min at 190° C. and 2.16 kg). This film, as well, was processed further in accordance with Example 1.

### EXAMPLE 4

A film of HDPE polyethylene (density 0.958 g/cm³, melt index 6 g/10 min at 190° C. and 2.16 kg), having a thickness of 70 μm, with an addition of 6 wt.-% titanium dioxide as white pigment, was extruded on a film blowing system. After a surface treatment using corona discharges, the film was coated with an acrylic polymer and, after UV curing, it was wound up. As in Example 1, the film was successfully used for labeling containers.

### EXAMPLE 5

A film of HDPE polyethylene (density 0.958 g/cm³, melt index 6 g/10 min at 190° C. and 2.16 kg) having a thickness of 70 μm was extruded on a film blowing system. After a surface treatment using corona discharges, the label film was coated with an acrylic polymer dissolved in ethyl acetate and, after drying, wound up. The label film could be processed further in accordance with Example 1, and could be used successfully for labeling containers.

### EXAMPLE 6

A label film of HDPE polyethylene (density 0.958 g/cm³, melt index 6 g/10 min at 190° C. and 2.16 kg) having a thickness of 70 μm was extruded on a film blowing system. After a surface treatment using corona discharges, the label film was coated with an aqueous dispersion of an acrylic polymer and, after drying, wound up. The label film was processed further in accordance with Example 1, and could be used successfully for labeling containers.

Although several embodiments of the present invention have been shown and described, it is to be understood that many changes and modifications may be made thereunto without departing from the spirit and scope of the invention as defined in the appended claims.

1. A label film laminate comprising
(a) a carrier; and
(b) a label film releasably disposed on said carrier, said label film being printable and suitable for punching and comprising a single-layer or a multi-layer polyethylene extrusion film having a film thickness of less than 85 μm, said extrusion film comprising a high-density polyethylene (HDPE) having a density of more than 0.950 g/cm³ at least in outer areas of said extrusion film.

2. The label film laminate as recited in claim 1, wherein the extrusion film is a multi-layer film comprising a core layer disposed between outer layers, said core layer comprising a polyethylene polymer selected from the group consisting of low-density polyethylene (LDPE) and linear low-density polyethylene (LLDPE) having a density of less than 0.945 g/cm³, said outer layers comprising high-density polyethylene (HDPE).

3. The label film laminate as recited in claim 1, wherein the outer areas have a thickness of at least 15 μm.

4. The label film laminate as recited in claim 1, wherein the extrusion film is a single-layer monofilm made of high-density polyethylene (HDPE) having a density of more than 0.950 g/cm³.

5. The label film laminate as recited in claim 1, wherein the extrusion film has a surface treated with corona discharges.

6. The label film laminate as recited in claim 1, wherein at least one side of the extrusion film is coated with a polymer to improve adhesion of inks and adhesives.

7. The label film laminate as recited in claim 6, wherein the coating comprises an acrylic polymer.

8. The label film laminate as recited in claim 6, wherein the coating has a layer thickness of 0.1 μm to 5 μm.
